(19) United States
(12) Patent Application Publication
(10) Pub. No.: US 2012/0317104 A1
(43) Pub. Date: Dec. 13, 2012

(54) Using Aggregate Location Metadata to Provide a Personalized Service

(75) Inventors: Filip Radlinski, Vancouver (CA); Paul N. Bennett, Kirkland, WA (US); Ryen W. White, Woodinville, WA (US); Emine Yilmaz, Cambridge (GB)

(73) Assignee: MICROSOFT CORPORATION, Redmond, WA (US)

(21) Appl. No.: 13/158,483

(22) Filed: Jun. 13, 2011

(51) Int. Cl. G06F 17/30; G06F 15/18

(52) U.S. Cl. 707/724; 706/12; 707/E17.014

(57) ABSTRACT

Functionality is described herein which generates a plurality of item models based on the aggregate behavior of users, such as the aggregate behavior of the users in selecting network-accessible sites and/or issuing particular queries. In one implementation, each item model estimates a probabilistic distribution of locations for an individual, given that the individual selects a particular item (e.g., a particular site or query). The functionality can use the item models to provide a personalized service to an end user. For example, in one scenario, the functionality can generate a plurality of location-based features based on the item models. The functionality can then learn a ranking model based on the location-based features. In a real-time phase of operation, a query processing system uses the ranking model to personalize search results for an end user.

### BACKGROUND

A search engine may use various strategies to personalize its search results for particular end users. For example, a search engine may rank search result items based, in part, on the interests of a particular user who is conducting a search. In addition, or alternatively, a search engine may rank search result items based, in part, on the assessed location of the user. Known location-based personalization can be performed for even new users encountered for the first time, e.g., without accumulating information regarding the interests of the users.

Different techniques exist to personalize search results based on location. In one known technique, the search engine may attempt to determine a location of the user, e.g., commonly based on the IP address associated with the user's device. The search engine may then attempt to find search results which pertain to the identified location. For example, the search engine may attempt to find websites that have content that matches the location of the user. If, for instance, the location of the user corresponds to Redmond, Wash., the search engine can examine its search index to identify websites which contain or are otherwise associated with this city.

The above personalization strategy is effective in some scenarios. But there is considerable room for improvement in known location-based personalization strategies.

### SUMMARY

Functionality is described herein which generates a plurality of item models based on the aggregate behavior of users. For example, the system generates a set of site models based on the sites accessed by the users. The functionality also generates a set of query models based on the queries issued by the users. Each item model estimates a probabilistic distribution of locations for an individual, given that the individual selects a particular item. For example, a site model for a particular network-accessible site estimates a probabilistic distribution of locations for an individual, given that the individual selects the particular network-accessible site. A query model for a particular query estimates a probabilistic distribution of locations for an individual, given that the individual issues the particular query. More generally stated, the system can construct an item model with respect to any type (or types) of metadata observation(s); the location of a site or query is just one such metadata property.

The functionality can use the item models to provide a personalized service to an end user. For example, in one scenario, the functionality can generate a plurality of location-based features based, in part, on the item models. The functionality can then learn a ranking model based on the location-based features. In a real-time phase of operation, a query processing system can use the ranking model to personalize search results for an end user. The personalized search results may boost search result items which pertain to an assessed location of the end user.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative training system for generating a plurality of item models based on the aggregate behavior of a group of data-providing users. The training system also generates a ranking model using the item models.

FIG. 2 depicts a probabilistic distribution provided by a site item model.

FIG. 3 depicts a probabilistic distribution provided by another site item model.

FIG. 4 shows an illustrative query processing system for applying the item models generated in FIG. 1 to provide a personalized service.

FIG. 5 shows a two-stage ranking module that can be used in the query processing system of FIG. 4.

FIG. 6 shows an example of the operation of the query processing system of FIG. 4.

FIG. 7 shows a procedure that sets forth one manner by which the training system of FIG. 1 can generate a plurality of item models.

FIG. 8 shows a procedure for generating an item model in the form of a weighted mixture of Gaussian components.

FIG. 9 shows a procedure that sets forth one manner by which the training system of FIG. 1 can generate one or more ranking models, on the basis of the item models provided by the procedure of FIG. 7.

FIG. 10 is a flowchart that shows one manner by which the query processing system of FIG. 4 can provide a personalized search service using the item models provided by the procedure of FIG. 7 and the ranking model(s) provided by the procedure of FIG. 9.

FIG. 11 is a procedure that sets forth a two-stage ranking technique that can be used to implement the ranking in the procedure of FIG. 10.

FIG. 12 shows illustrative computing functionality that can be used to implement any aspect of the features shown in the foregoing drawings.

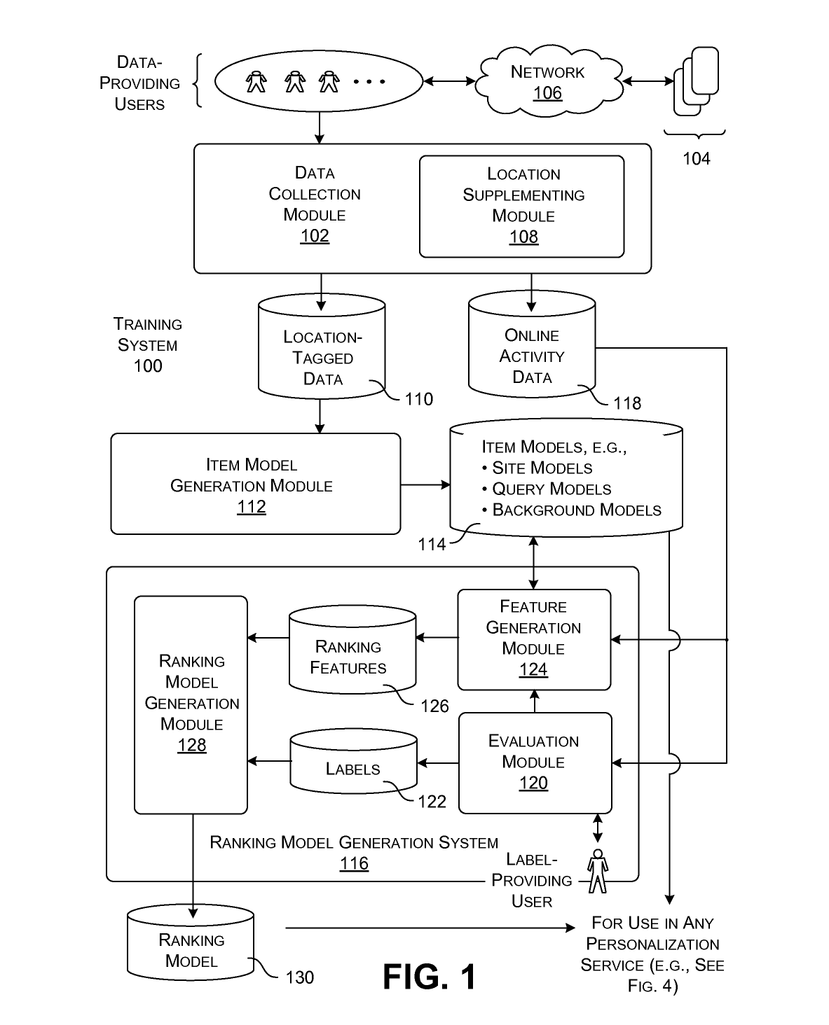

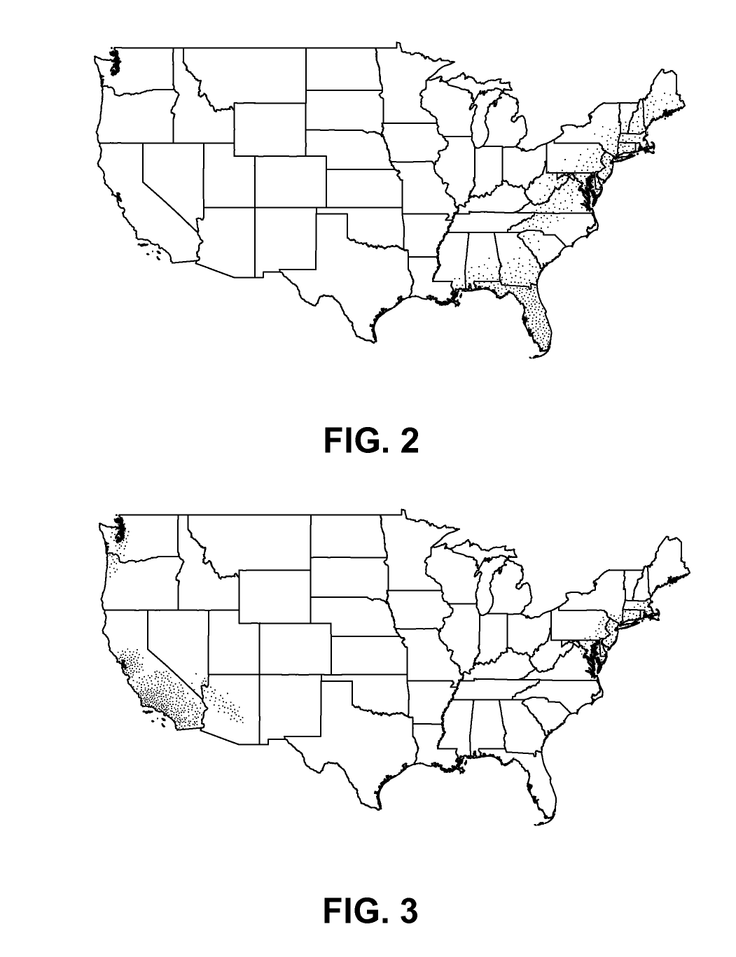

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes illustrative functionality for generating item models based on aggregate user behavior, and then using those models to provide a personalized service. Section B describes illustrative methods which explain the operation of the functionality of Section A. Section C describes illustrative computing functionality that can be used to implement any aspect of the features described in Sections A and B. Section D provides mathematical details regarding an approximation technique that can be used to calculate divergence between two Gaussian mixture models.

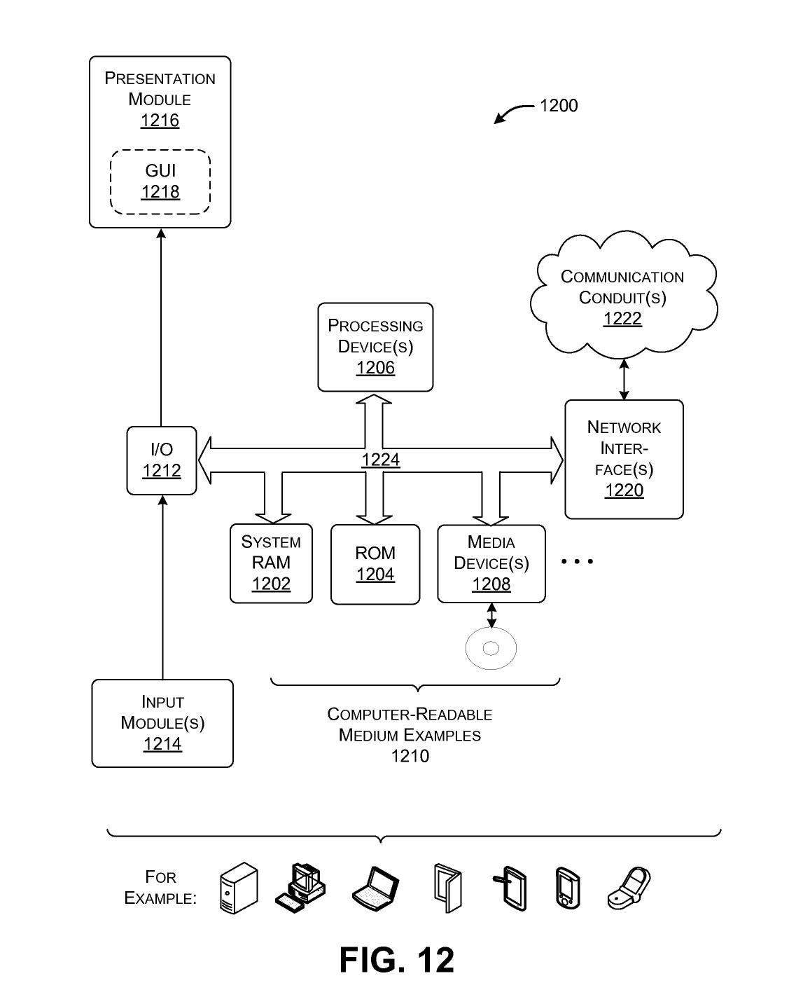

As a preliminary matter, some of the figures describe concepts in the context of one or more structural components, variously referred to as functionality, modules, features, elements, etc. The various components shown in the figures can be implemented in any manner by any physical and tangible mechanisms (for instance, by software, hardware, firmware, etc., and/or any combination thereof). In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 12, to be discussed in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms (for instance, by software, hardware, firmware, etc., and/or any combination thereof).

As to terminology, the phrase “configured to” encompasses any way that any kind of physical and tangible functionality can be constructed to perform an identified operation. The functionality can be configured to perform an operation using, for instance, software, hardware, firmware, etc., and/or any combination thereof.

The term “logic” encompasses any physical and tangible functionality for performing a task. For instance, each operation illustrated in the flowcharts corresponds to a logic component for performing that operation. An operation can be performed using, for instance, software, hardware, firmware, etc., and/or any combination thereof. When implemented by a computing system, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not expressly identified in the text. Similarly, the explanation may indicate that one or more features can be implemented in the plural (that is, by providing more than one of the features). This statement is not be interpreted as an exhaustive indication of features that can be duplicated. Finally, the terms “exemplary” or “illustrative” refer to one implementation among potentially many implementations.

### A. ILLUSTRATIVE SYSTEMS

FIG. 1 shows an illustrative training system 100 for generating models that may be used to provide a personalized service to an end user. This figure will generally be described in this section from top to bottom.

The training system 100 includes a data collection module 102 for collecting selection data from a plurality of users. These users are referred to herein as “data-providing users” to emphasize the fact that they provide data to the training system 100. The selection data represents the aggregate behavior of the data-providing users in selecting items. For example, in one scenario, the items that are selected by the data-providing users correspond to network-accessible sites 104 (referred to as simply “sites” herein). That is, the data-providing users use respective user devices (not shown) to access sites 104 via a network 106, such as a wide area network (e.g., the Internet). The term “sites” is used broadly herein to refer to any resource that can be selected by the data-providing users. In one case, for example, a site may refer to a particular website that is accessed by a data-providing user and is associated with a specific URL. In another case, a site may correspond to an object that is associated with any other identifier (e.g., not necessarily corresponding to a network-accessible address). In another case, a site may correspond to a general domain that is accessed by a data-providing user, etc. In addition, or alternatively, the items that are selected (in this case, issued) by the data-providing users correspond to queries submitted to a search engine.

The data collection module 102 can collect the selection data in various ways. In one way, each participating data-providing user can install a reporting module in his or her local browser module which forward (pushes) the selection data to the data collection module 102. Alternatively, or in addition, the data collection module 102 can receive the selection data using a pull technique, or some combination of a pull technique and a push technique. The training system 100 may sanitize the data to remove information which reveals the actual identities of data-providing users. For example, each instance of the selection data can provide a random-generated identifier that corresponds to a user, a date and time at which a selection was made, and a description of the selection (e.g., the address of a site that has been selected, or the content of a query that has been issued).

Alternatively, or in addition, the training system 100 may update models (to be described below) in a dynamic fashion, based on selections made by the data-providing users. In this case, the data collection module 102 need not archive an entire corpus of selection data for later use. Rather, the training system 100 can continuously or periodically use the selection data as it is received to update the models.

A location supplementing module 108 can add locations to the selection data (if not already provided by the selection data), to create location-tagged data. For example, the location supplementing module 108 can map the IP addresses of user devices (which provide the selection data) to geographic locations, at any level of granularity, e.g., using a reverse-IP lookup technique. In addition, or alternatively, the location supplementing module 108 can determine the locations of mobile user devices by relying on any type(s) of mobile location techniques, such as cell tower or WIFI triangulation, GPS determination, etc. In addition, or alternatively, the location supplementing module 108 can determine the locations of users based on user data supplied by the users, e.g., as expressed by the users' profile information and/or preference information. The location supplementing module 108 can rely on yet other techniques to determine the locations of the users.

The location supplementing module 108 can also use various approximation techniques to generalize the locations of the users. For example, in one implementation, the location supplementing module 108 identifies all data-providing users who are located in the same region (e.g., the same city, town, district, map tile, etc.) with the same geographical coordinates. The data collection module 102 can store the location-tagged data in a data store 110.

Stated in a more general way, the data collection module 102 associates a metadata observation with each selection made by a data-providing user. In the above example, the metadata observation corresponds to the geographic location at which the data-providing user has made the selection, or to the geographic location to which the selection otherwise pertains. In other implementations, the metadata observation can correspond to some other characteristic besides, or in addition to, location. For example, the data collection module 102 can associate any other characteristic of the data-providing user with a selection made by that data-providing user, such as the organizational affiliation of the data-providing user. But to facilitate explanation, the functionality will be mainly described herein in the illustrative context in which the metadata observations correspond to locations.

The data collection module 102 can also tag each instance of the location-tagged data with confidence information. The confidence information reflects the reliability of an assessed location for a particular selection made by a user who is using a particular user device. The data collection module 102 can generate the confidence information based on one or more environment-specific factors. One factor reflects the user device's demonstrated reliability in providing meaningful selection data. For example, consider the case of a user who lives in Seattle and frequently uses his or her home computer to research businesses and events in the Seattle region. The data provided by this user device is therefore a valid example of selections made by people who live in the Seattle region. Consider next the case of a public computer provided in an Internet café in the Seattle airport. This computer provides a less accurate representation of the behavior of people who live in Seattle, namely, because these users may not all live in Seattle, and the focus of their online activity may be diverse. The data collection module 102 can therefore suitably discount the relevance of the selection data in the latter case.

An item model generation module 112 creates a plurality of item models based on the location-tagged data. Each item model describes a probabilistic distribution of locations associated with an individual, given that the individual is considered to have selected a particular item. For example, the item model generation module 112 generates a plurality of site models for respective sites that the data-provider users have accessed. Each site model describes a probabilistic distribution of locations associated with an individual, given that the individual is considered to have accessed that particular site. Similarly, a query model describes a probabilistic distribution of locations associated with an individual, given that the individual is considered to have issued a particular query.

To repeat, location is one metadata observation (e.g., property) among many. Stated more broadly, each item model provides a probabilistic distribution of metadata observations associated with an individual, given that the individual is considered to have selected a particular item. Further, in some cases, an item model can be framed in the context of a single type of metadata observation, such as location. In other cases, an item model can express joint probability associated with two or more properties, such as by modeling the probability that an individual within a certain age group accesses a site or issues a query within a particular region. That is, this joint item model can express a distribution of locations, in conjunction with a distribution of ages, given that a particular user has selected a particular site or issued a particular query. Henceforth, any mention of an item model can refer to a single-property model that expresses probability with respect to a single type of metadata observation or a joint model that expresses probability with respect to two or more types of metadata observations.

The item model generation module 112 also generates one or more background models. For example, the item model generation module 112 generates a background site model that describes a distribution of locations at which the data-providing users have accessed a plurality of sites. The item model generation module 112 also generates a background query model that describes a distribution of locations at which the data-providing users have issued a plurality of queries. These background models are generally expected to model the population distribution within a particular geographic region under consideration, such as the United States. In the following description, it will be assumed that the background site model is distinct from the background query model. For example, the background site model and the background query model may be derived based on different respective data sources. But in other cases, the background site model can be the same as the background query model, i.e., M_{bu}=M_{bq}.

The site models, query models, and background models are referred to generically as item models herein. The item model generation module 112 can store the item models in a data store 114. In one case, the item model generation module 112 will not generate a model for an item if that item has not been selected by users at least a threshold number of times. In another case, the item model generation module 112 can identify relationships between similar items (e.g., between similar sites or similar queries). The item model generation module 112 can then use the item model for a popular item to also represent the behavior of users with respect to a similar unpopular item. This is one way, for example, to quickly bootstrap the training system 100 with respect to the introduction of new items. It is also possible to generate item models that refer to selections made by certain groups or classes of people. Those models describe the distributions of selections made of those groups of people, rather than the general population.

As will be set forth below, the item model generation module 112 can represent the item model in a compact form. This expedites the storage, retrieval, and processing of the item models. For example, in one approach, each model can be represented by a set of parameters.

The item model generation module 112 can use any technique to generate the item models. For example, the item models may represent Gaussian mixture models (GMMs). Each GMM comprises a weighted combination of Gaussian components. The item model generation module 112 can learn each GMM using the expectation-maximization (EM) technique. Section B describes the characteristics and training of the GMMs in greater detail. Generally, the GMMs provide continuous distributions of locations over a two-dimensional space.

Alternatively, or in addition, the item model generation module 112 can form discrete item models. For example, the item model generation module 112 can break up a map into discrete regions having any level of granularity, such as country level, state or province level, county level, city level, zip code level, school district level, map tile level, etc. The item model generation module 112 can then count the items that have been selected by the data-providing users within each discrete region. The item model generation module 112 can then divide each regional count by a total number of selections over the entire map, thereby providing an indication of the relative number of selections that have been made in each discrete region. In addition, the item model generation module 112 can compute a level of uncertainty associated with each discrete region. A region with a sparse amount of location-tagged data can be expected to have a higher level uncertainty than a region that has a large collection of high-quality location-tagged data.

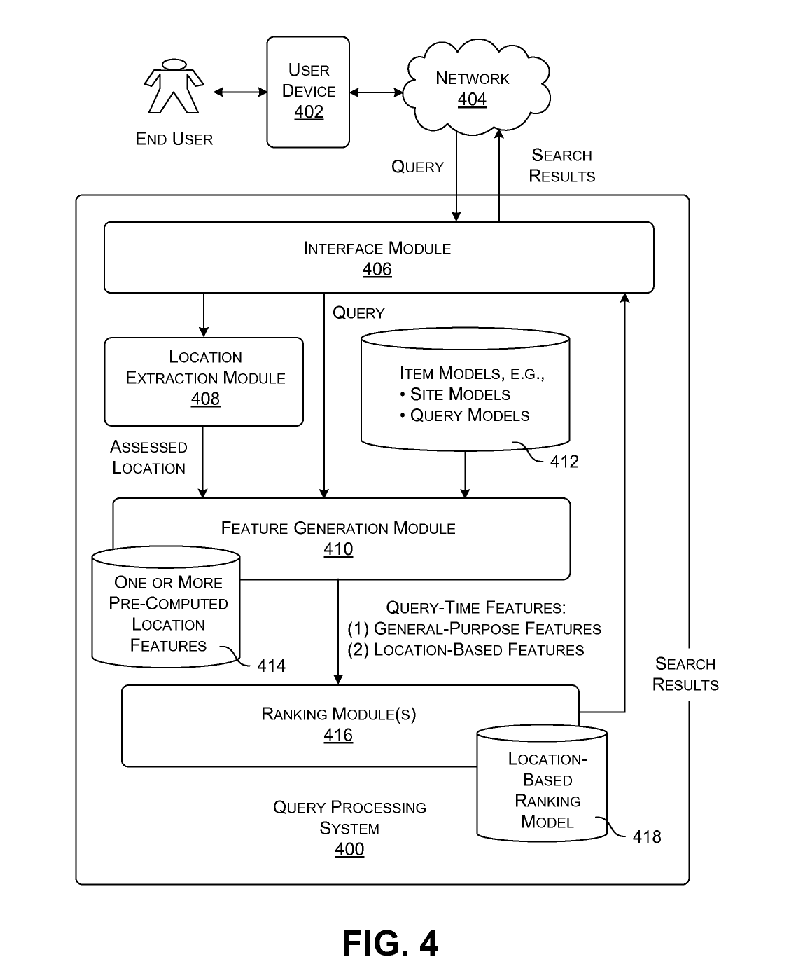

A ranking model generation system 116 uses the item models stored in the data store 114 to generate a ranking model. In a real-time phase of operation, a query processing system 400 (to be described below with reference to FIG. 4) can use the ranking model to generate search results, e.g., either in a single-stage ranking operation or a dual-stage ranking operation; in the latter case, the query processing system 400 generates an initial list of ranked result items and then performs location-based re-ranking on this initial list to generate a re-ranked list of result items. The ranking model generation system 116 generates the ranking model based on user online activity data provided in a data store 118. In one case, the user online activity data corresponds to a different dataset than the location-tagged data (described above). In another case, the user online activity data may at least overlap with any part of the location-tagged data. The data collection module 102 may also annotate the user online activity data with assessed locations in the manner described above.

The user online activity data encompasses any online behavior exhibited by the data-providing users. For example, the online activity data may include user session data. The data collection module 102 can provide the user session data based on search-related behavior exhibited by the data-providing users. More specifically, in one case, the user session data may identify: queries submitted by the data-providing users; the top n search result items returned by a search engine in response to each of the queries; and selections (e.g., “clicks”) within the search results (made by the data-providing users). In addition, or alternatively, the online activity data can include other online behavior information, such as mobile log data, browsing history data, etc. But to facilitate explanation, the online activity data will be described below mainly in the context of user session data, which may include the type of collected data described above.

An evaluation module 120 applies labels to the online activity data. For example, for each pairing of a query and a search result item, a label indicates an extent to which the search result item satisfies the query. For example, consider the query “Redmond dry cleaning,” together with a particular result item associated with a particular business. The label indicates the extent to which the result item satisfies the user's search objective which underlies the query. In one case, the evaluation module 120 may represent an interface by which a human analyst (a label-providing user) may review the user online activity data and manually apply labels to the query-item pairs. Alternatively, or in addition, the evaluation module 120 can automatically apply labels to the query-item pairs. For example, the evaluation module 120 can analyze the click behavior of the users to apply the labels, taking into account search result items that the users have clicked on, the search result items that the users did not click on, and/or both.

Different strategies can be used to apply the labels. Consider, for instance, the case in which a search engine delivers n search result items and the user selects one of the items (e.g., by clicking that item). Further assume that this click is the last click in the user's search session. In this situation, the evaluation module 120 can provide a positive label for the search result item that has been clicked on, and negative labels to those non-clicked search result items that are ranked above the search result item that the user has clicked on. This is based on the premise that the user is likely to have considered (and rejected) these higher-ranked search result items. The evaluation module 120 can store the labels for the user online activity data in a data store 122.

A feature generation module 124 can generate descriptive features which characterize the user online activity data that has been labeled by the evaluation module 120. Section B describes a collection of possible features in detail. By way of overview, features in a first class do not depend on user location, and therefore comprise non-contextual features. Features in a second class are dependent on user location, and therefore comprise contextual features. In both cases, the feature generation module 124 may use the item models in the data store 114 to generate the features. For example, some features represent characteristics of a particular item model (either a site model or a query model) considered in itself. Other features represent characteristics of one item model when compared to another item model. For example, one type of feature compares the divergence of a site model (or query model) with respect to a background site model (or background query model, respectively). The feature generation module 124 can store the features in a data store 126.

Finally, a ranking model generation module 128 generates one or more ranking models on the basis of the features in the data store 126 and the labels in the data store 122. From a high-level standpoint, the ranking model generation module 128 employs machine learning techniques to learn the manner in which the features are correlated with the judgments expressed by the labels. The ranking model generation module 128 can use any algorithm to perform this operation, such as, without limitation, the LambaMART technique described in Wu, et al., “Ranking, Boosting, and Model Adaptation,” Microsoft Research Technical Report MSR-TR-2008-109, Microsoft® Corporation, Redmond, Wash., 2008, pp. 1-23. The LambaMART technique uses a boosted decision tree technique to perform ranking. More generally, machine learning systems can draw from any of: support vector machine techniques, genetic programming techniques, Bayesian network techniques, neural network techniques, and so on. The ranking model generation module 128 stores the ranking model(s) in a data store 130. A ranking model may comprise a collection of weights applied to the features.

The training system 100 can be implementing by any computing functionality, such as one or more computer servers, one or more data stores, routing functionality, etc. The functionality provided by the training system 100 can be provided at a single site (such as a single cloud computing site) or can be distributed over plural sites.

FIG. 2 depicts a distribution of locations expressed by a site model for a particular network-accessible site. More specifically, assume that this site describes the services provided by an insurance provider that predominately serves the residents of Florida, and, to a lesser extent, residents of other East-coast states. The dots represent locations at which data-providing users have accessed this site. As indicated, the state of Florida has the greatest density of dots, indicating that the majority of users have accessed this site from locations within the state of Florida. Other East coast states exhibit a lower density of dots.

FIG. 3 shows a distribution expressed by another site model for another particular site. More specifically, assume that this site corresponds to the online version of the Los Angeles Times. As can be expected, southern California exhibits the highest density of dots for this site. Other regions of California (such as the Bay area) also exhibit a high density of dots. Other cities (such as Seattle, Portland, Boston, New York, Philadelphia, etc.) may exhibit a lower density of dots, generally indicating that the Los Angeles Times remains somewhat popular with some non-Californian urban populations.

Each of the site models in FIGS. 2 and 3 can be expressed as a continuous distribution of locations and/or a discrete representation of locations. A discrete representation of locations can have any level of regional granularity, such as a state level, county level, etc.

For example, a GMM can be used to represent a continuous distribution of locations. For example, the item model generation module 112 can generate a weighted combination of n Gaussian components which, in aggregate, produces the distribution pattern for the Los Angeles Times site shown in FIG. 3. In many cases, a single (or small number) of Gaussian components may predominately represent the distribution in a particular part of a map. If so, the item model generation module 112 can further simplify the GMM by tagging each region with its most representative Gaussian component (or components). For example, assume that one or more Gaussian components well represents the readership of the Los Angeles Times in the Portland-Seattle region; if so, the item model generation module 112 can tag that region with its telltale Gaussian component(s), eliminating the tail contributions of other Gaussian components in the GMM (for that region). This model is therefore partially discrete and partially continuous. Namely, the model is discrete insofar as it adopts a different strategy for each region; it is also continuous in the sense that, within a region, it provides a continuous distribution of locations. Still further techniques can be used to simplify the item models, thereby improving their compactness. Compactness refers to the amount of computer resources (e.g., memory, etc.) that is required to implement the item models.

Advancing to FIG. 4, this figure shows a query processing system 400 that uses the ranking model (generated by the training system 100 of FIG. 1) to provide personalized search results to end users. In one implementation, the training system 100 of FIG. 1 operates in an off-line training stage, while the query processing system 400 operates in a real-time dynamic search phase. However, any aspects of the functions performed by the training system 100 can also be performed in a dynamic real-time manner. For example, the training system 100 can use the search behavior of the end users to continuously or periodically re-generate updated versions of the item models and the ranking model(s).

The query processing system 400 can be implementing by any computing functionality, such as one or more computer servers, one or more data stores, routing functionality, etc. The functionality provided by the query processing system 400 can be provided at a single site (such as a single cloud computing site) or can be distributed over plural sites. The query processing system 400 may be informally referred to as a search engine.

Any end user may interact with the query processing system 400 using any user device 402. For example, the user device 402 may comprise a personal computer, a computer workstation, a game console device, a set-top device, a mobile telephone, a personal digital assistant device, a book reader device, and so on. The user device connects to the query processing system 400 via a network 404 of any type. For example, as previously stated, the network 404 may comprise a local area network, a wide area network (e.g., the Internet), a point-to-point connection, etc., as governed by any protocol or combination of protocols.

The query processing system 400 may employ an interface module 406 to interact with the end user. More specifically, the interface module 406 receives search queries from the end user and sends search results to the end user. The search results generated in response to a query represent the outcome of processing performed by the query processing system 400. The search results may comprise a list of search result items that have been ranked in a personalized manner for the end user.

A location extraction module 408 associates an assessed location with a query submitted by a user. In one case, the location extraction module 308 determines the location of the end user based on any evidence of the physical location from which the user has submitted his or her query, such as the IP address of the user device 402, the location of a mobile user device (e.g., as assessed by triangulation, GPS, etc.), and so on. Alternatively, or in addition, the location extraction module 408 can determine the location of the end user based on a geographic target of one or more queries submitted by the user within a search session. For example, the location extraction module 408 can determine that the location associated with the user is Paris, France, if the user makes a series of inquiries about hotel accommodations in Paris, France, even though the user may be conducting her searches from Redmond, Wash.

A feature generation module 410 generates features for each combination of the query with a particular candidate site (associated with a candidate identifier). More specifically, the feature generation module generates the features based on at least: the query submitted by the user; information regarding a candidate site under consideration; the assessed location (provided by the location extraction module 408); and the item model(s) for the particular query-site pairing under consideration (if, in fact, these site models exist for this particular pairing of query and site). The item models can be retrieved from a data store 412.

From a high-level perspective, the feature generation module 410 generates query-time features. The query-time features, in turn, can include the same type of location-based features generated by the training system 100, described in greater detail in Section B. In addition, the feature generation module 410 can generate other general-purpose features that are not based on the item models.

In some cases, the feature generation module 410 computes the query-time features in real-time in response to the submission of a particular query. Alternatively, or in addition, the feature generation module 410 can retrieve pre-computed features from a data store 414. For example, whenever possible, the training system 100 can pre-generate these features and store them as part of a search index. The query processing system 400 can retrieve the features from the search index in the real-time phase of operation without incurring computing costs.

Finally, at least one ranking module 416 determines a list of search result items to present to the user in response to the submission of a particular query. In one implementation, the ranking module 316 can performs this operation in a single stage based on a combination of the general-purpose features and the location-based features. In performing this operation, the ranking module relies on a location-based ranking model provided in a data store 418, as provided by the training system 100.

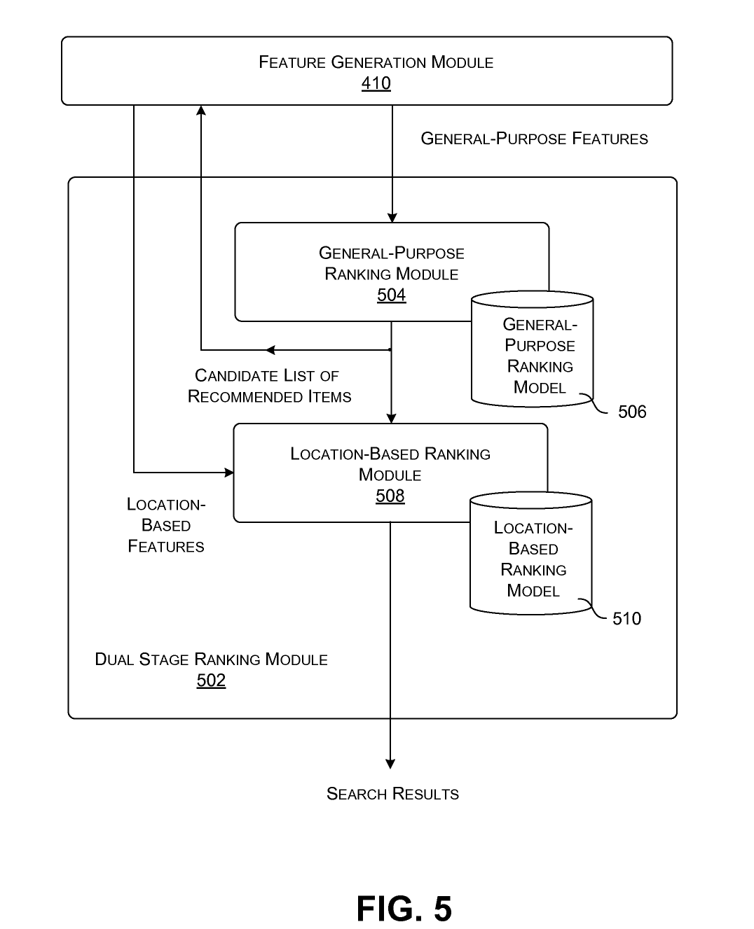

FIG. 5 represents another type of ranking module 502 that generates the search results in a two-stage process In a first stage, a general-purpose ranking module 504 generates a candidate list of search result items based on the general-purpose features provided by the feature generation module 410. It performs this task based on a general-purpose ranking model provided in a data store 506. Less formally stated, the general-purpose ranking module 504 can represent whatever functionality that a search engine uses to generate its search results, without the contribution of the location-model-based personalization described herein.

A location-based ranking module 508 then consults the feature generation module 410 to obtain a set of location-based features for the sites in the candidate list of search result items. The location-based ranking module 508 uses these location-based features to re-rank the search result items in the candidate list. The location-based ranking module 508 also treats any type of ranking and/or score information provided by the general-purpose ranking module 504 as additional features to take into consideration. The location-based ranking module 508 performs its operations using a location-based ranking model provided in a data store 510, as provided by the training system 100.

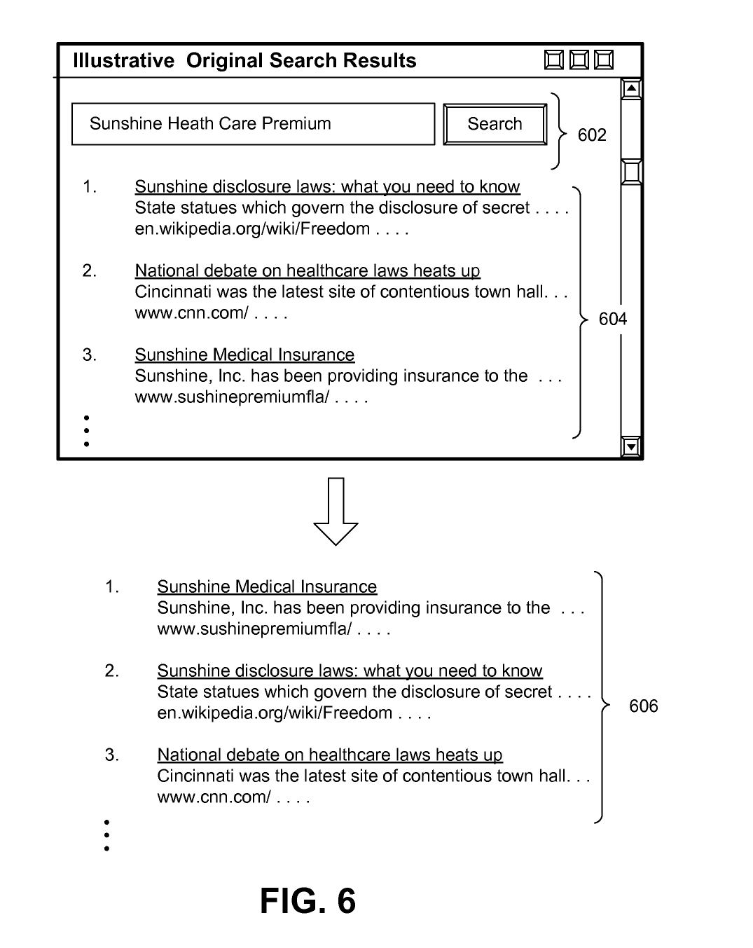

FIG. 6 shows an example of the operation of the query processing system 400 of FIG. 4. In this case, the end user accesses the query processing system 400 via a browser module of his or her user device 402. Assume that the user next enters the search query “Sunshine Health Care Premium” into an input field 602, with the intent of accessing a network-accessible site dedicated to a company named “Sunshine, Inc.” headquartered in Nevada, but predominantly providing service to the residents of Florida (as in the example of FIG. 2). Further assume that the end user who has submitted this query is also a resident of Florida (and that the user submits the query from a location in Florida).

First consider the behavior of the query processing system 400 without the application of location-based personalization. In this case, the query processing system 400 might generate the hypothetical list 604 of search result items shown in FIG. 6. The third entry corresponds to the desired target of the user's search. The first two search result items pertain to sites that are completely irrelevant to the user's search objective.

Now consider the behavior of the query processing system 400 with the application of the location-based personalization described herein. In this case, the query processing system 400 generates a list 606 of search result items, where the most relevant entry now appears at the top of the list. In the first mode of operation (using a single-phase ranking operation), the query processing system 400 will generate the list 606 without first generating a preliminary candidate list. In the second mode of operation (using the two-stage ranking module 416 of FIG. 5), the query processing system 400 will internally generate the candidate list 604, and then perform location-based re-ranking to provide the final list 606. (The preliminary list 604 is not actually displayed to the user in this scenario; it is shown in FIG. 6 to clarify the operation of the query processing system 400.) Alternatively, or in addition, the query processing system 400 can provide other mechanisms to designate search result items which match the user's location, such as by graphically highlighting those result items within the search results, etc.

Prior personalization techniques may be unable to produce the results shown in FIG. 6. For example, consider the type of personalization technique which mines the content of a website to extract information regarding the location of the website, and then uses the extracted information as evidence of the relevance of the site to the user's location. In this case, Sunshine, Inc. is located in Nevada, so it is possible that this type of personalization technique may not properly promote the site for Sunshine, Inc. (presuming that the website prominently features the word “Nevada”). In contrast, the functionality described herein bases its analysis on the aggregate behavior of users who access the site, revealing that the majority of users access this site from Florida.

FIGS. 4-6 represent one among many applications of the item models provided by the training system 100. In another application, an advertising system can use the item models to provide ads to the end users based on the locations of the end users. In another case, a product recommendation system can use the item models to provide recommendations to end users based on the locations of the end users. In another case, a social network system can use the item models to provide suggested social connections (or other recommendations) based on the locations of end users. In another case, an advertising system can use the item models to provide a new bidding system, e.g., by allowing advertisers to bid on ads based on location, and so on.

In another application, an environment can generate query models based on queries submitted by data-providing users. These query models reveal the extent to which each query is sensitive to location. The environment can then leverage the insight provided by the query models to generate a particular training (and/or evaluation) dataset for use in producing a search engine's ranking model. For example, the environment can produce a dataset that targets a particular region and/or market (e.g., the Northeast part of the United States), e.g., by including queries that are associated with that region, as revealed by the models. Alternatively, the environment can produce a dataset that is relatively independent of location, e.g., by including queries that not associated with any particular regions.

Further, as explained above, other systems can leverage other metadata observations associated with users besides, or in addition to, location. For example, other systems can generate and apply item models that take into consideration organizational affiliation, education level, political affiliation, reading level, etc., or any combination of two or more types of metadata observations.

### B. ILLUSTRATIVE PROCESSES

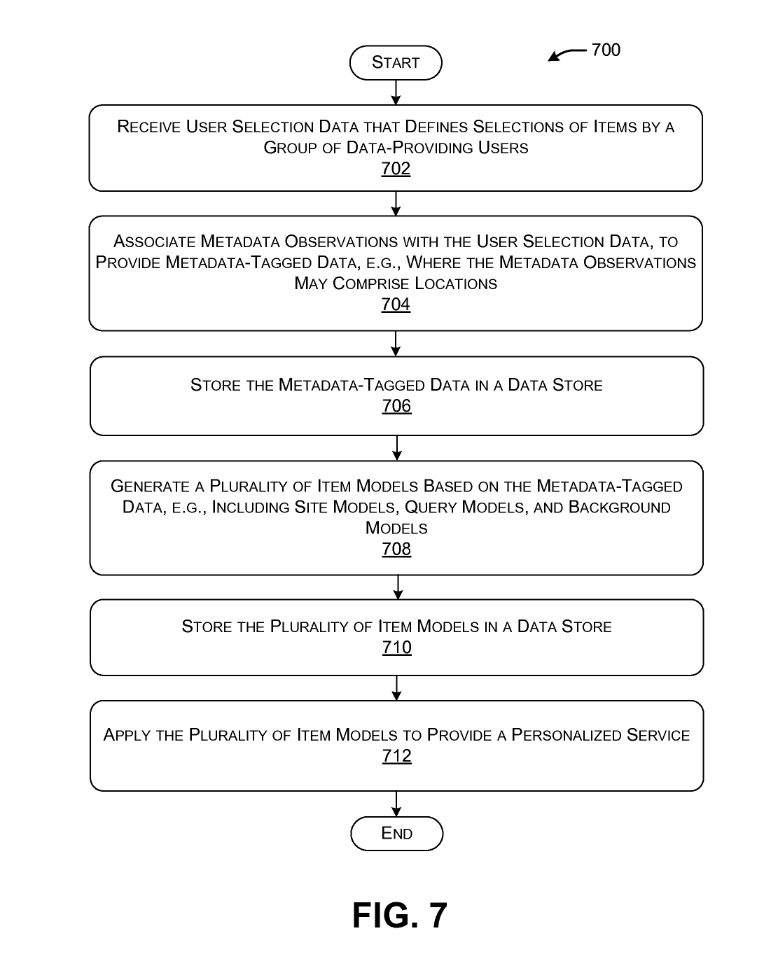

FIGS. 7-11 show procedures that represent one implementation of the functionality described in Section A. Since the principles underlying the operation of the training system 100 and query processing system 400 have already been described in Section A, certain operations will be addressed in summary fashion in this section.

Starting with FIG. 7, this figure shows a procedure 700 that explains one manner of operation of the training system 100 of FIG. 1. In block 702, the training system 100 receives user selection data. That selection data defines selections of items by a group of data-providing users, such as sites and/or issued queries.

In block 704, the training system 100 can annotate the selection data with metadata observations. For example, the metadata observations may correspond to locations associated with the data-providing users. This operation yields metadata-tagged data, e.g., location-tagged data. In block 706, the training system stores the metadata-tagged data in a data store (e.g, on a long-term basis or a short-term basis, etc.).

In block 708, the training system 100 generates a plurality of item models on the basis of the metadata-tagged information. Each item model describes a probabilistic distribution of metadata observations for an individual, given that the individual has selected a particular item. For example, the training system 100 can generate a plurality of site models and a plurality of query models. In block 710, the training system 100 can store the plurality of item models in a data store.

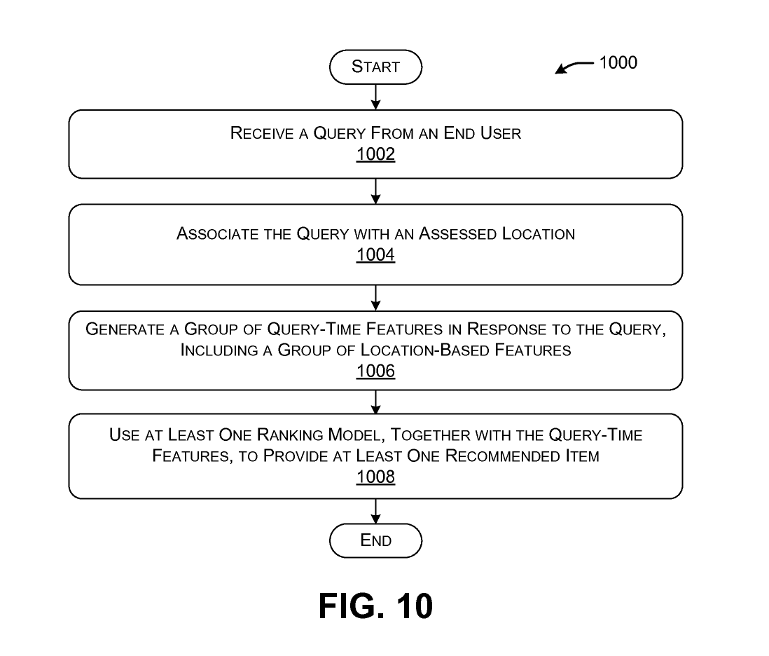

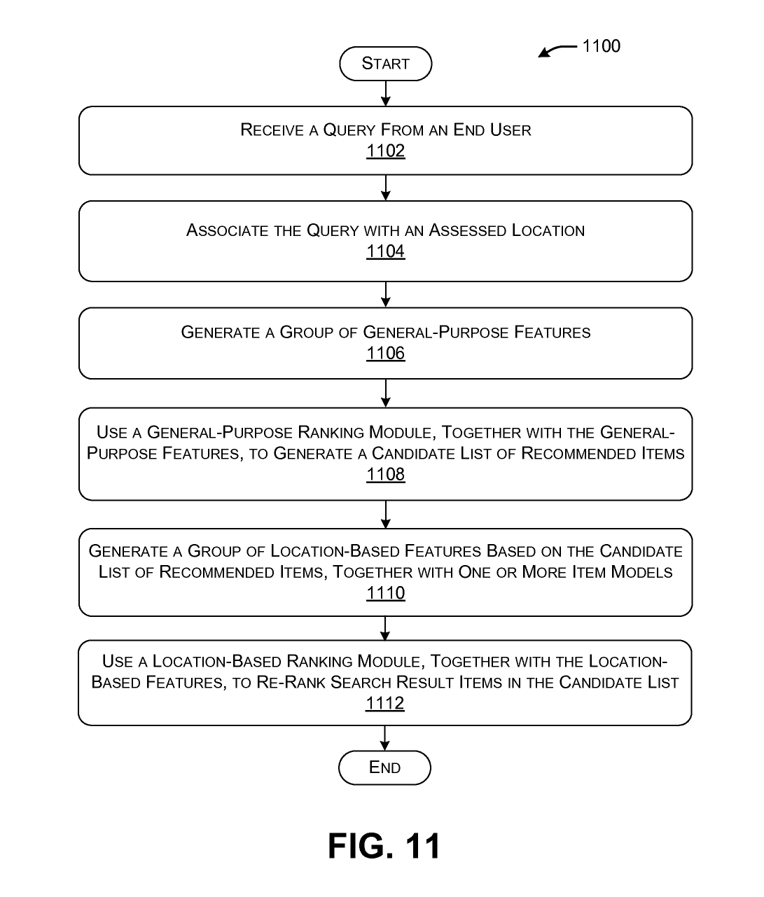

In block 712, any functionality can apply the item models to provide a personalized service to an end user. For example, the query processing system 400 can apply the item models to provide location-customized search results. FIGS. 10 and 11 provide additional information regarding this implementation of block 712. Block 712 reflects one particular application of the item models. However, as explained in Section A, other environments can apply the item models in other ways.

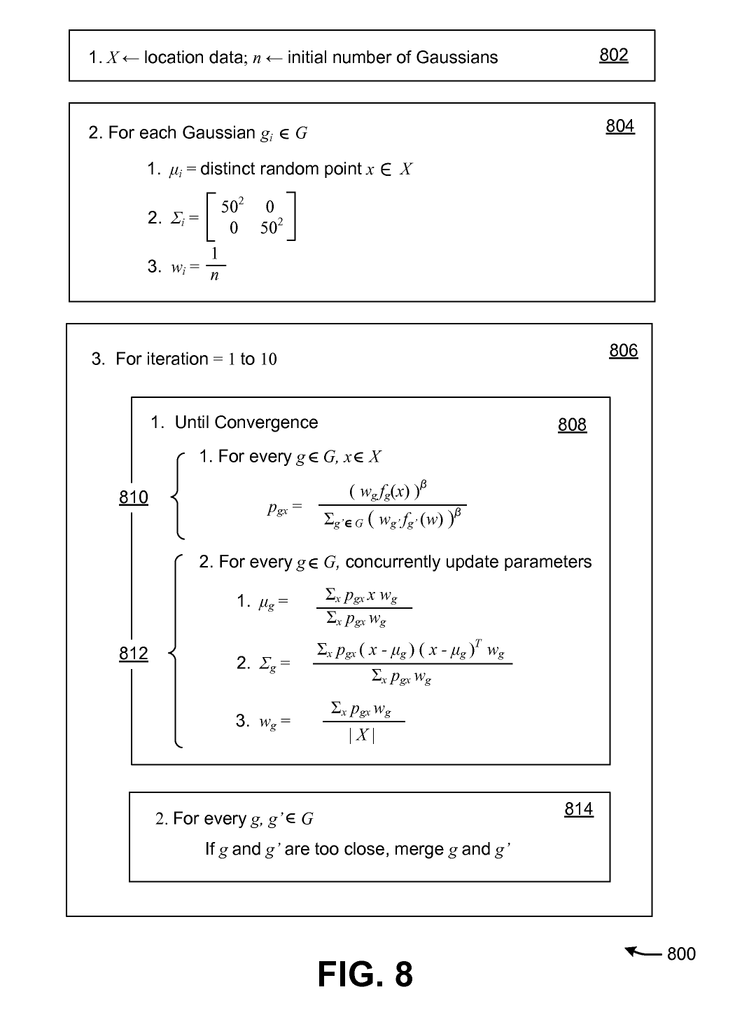

FIG. 8 shows one procedure 800 for generating a GMM item model using the expectation-maximum (EM) technique. In particular, the procedure 800 will be described in the context of the generation of an item model, but the same approach can be used to generate a query model.

Each GMM includes a weighted mixture of two-dimensional Gaussian components. The following expression defines a GMM according to one implementation:

$$\begin{matrix}P ( location = x \vert site ) = {\sum }_{i = 1}^{n} {w}_{i} N ( x ; {μ}_{i} , {Σ}_{i} ) \\ = {\sum }_{i = 1}^{n} \frac{{w}_{i}}{{( 2 π )}^{2} {\vert {Σ}_{i} \vert}^{1 / 2}} exp ( - \frac{1}{2} {( x - {μ}_{i} )}^{T} {Σ}_{i}^{- 1} ( x - {μ}_{i} ) ) .\end{matrix}$$

P(location=x|site) expresses the probabilistic distribution of locations (x), given a site (site). Each Gaussian component i is characterized by three parameters, uᵢ (representing the mean of the component), Σᵢ (representing the covariance of the component), and wᵢ (representing a weight applied to the component in the GMM). There are a total number of n Gaussian components in the model, e.g., between 5 and 25 in one implementation (depending on the amount of location data available for each site).

Block 802 indicates that the EM technique is performed over location data X, specifying individual locations x. Further, the EM technique is performed to generate a set of Gaussian components G of the GMM, having individual components gᵢ.

In block 804, the item model generation module 112 initializes the Gaussian components. For example, steps 1 and 2 of this operation indicate that the item model generation module 112 initializes the x values to random observed locations, with high initial variance (e.g., in one example, 50 degrees in each direction, e.g., corresponding to 5,500 km)

In block 806, the item model generation module 112 generates the GMM. Namely, in block 808, the EM technique alternates between an expectation (E) step (in block 810) and a maximizing (M) step (in block 812). In the expressions in block 808, p_{g}, represents the probability distribution of a Gaussian component g, and f_{g} represents the inner term in the above expression, namely N(x; μᵢ,Σᵢ). From a high-level perspective, the EM technique iterates between estimating the probability that each point belongs to each Gaussian component (p_{gx}), and estimating the most likely mean, covariance and weight of each Gaussian component (μ_{g},Σ_{g},w_{g}). In one implementation, the parameter β is set to 0.9. As the algorithm progresses, each Gaussian component tends to narrow and migrate to a high density area, or broaden to cover a background probability over large geographic areas (depending on the nature of the particular distribution under consideration).

In block 814, the item model generation module 112 merges any two Gaussian components that are similar. This makes the GMM more compact by eliminating substantially redundant components. For example, the item model generation module 112 can merge Gaussian components that have means that differ from each other by less than one degree, and, likewise, have similar covariances. Setting the value β equal to 0.9 (rather than a value of 1.0), encourages the Gaussian components to be nearby each other in the E step (block 810).

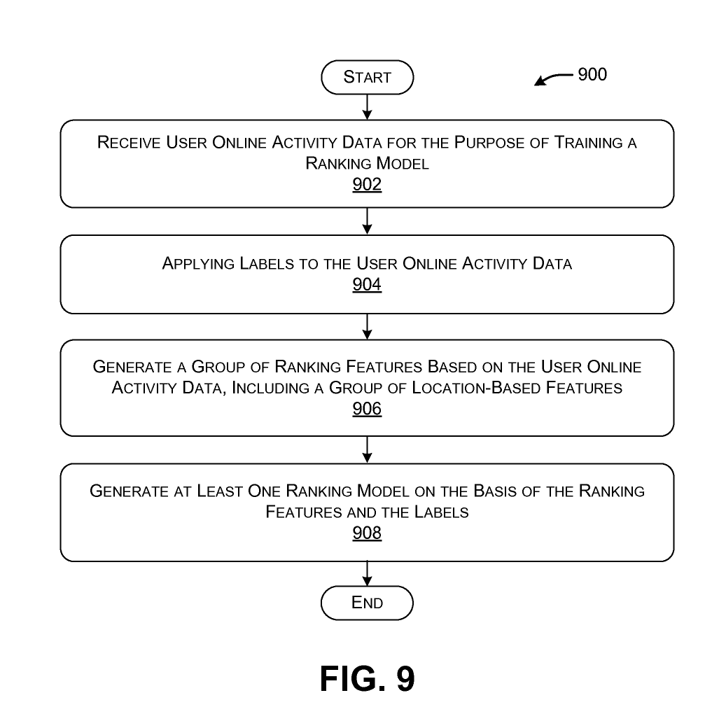

Advancing to FIG. 9, this figure shows a procedure 900 for generating a ranking model, e.g., using the ranking model generation system 116 shown in FIG. 1. In block 902, the training system 100 receives user online activity data, such as user session data. In block 904, the training system 100 applies labels to the user online activity data, either in a manual manner, an automatic manner, or some combination thereof. In block 906, the training system 100 generates a group of ranking features for the user online activity data that has been labeled in block 904, including a group of location-based features. The training system 100 generates the location-based features, in part, based on the item models. In block 908, the training system 100 generates the ranking model on the basis of the ranking features (generated in block 906) and the labels (generated in block 904).

Different implementations of the feature generation module 124 can extract different characteristics of the item models to generate the location-based features. Without limitation, the following explanation sets forth one set of possible set of thirty location-based features that can be generated.

In general, the location-based features can be divided into two classes. A first class corresponds to features that do not depend on the locations of individuals. These are referred to as non-contextual features. These features indicate whether individual sites and queries are location sensitive per se. The second class depends on the locations. These are referred to as contextual features. The contextual features indicate whether particular pairings of locations and sites (or locations and queries) are location sensitive. In the following description, Mᵤ refers to a site model for a particular site u (e.g., a URL, for instance), M_{q} refers to a query model for a particular query q, M_{bu} refers to a background site model, and M_{bq} refers to a background query model.

Non-Contextual Features

Aggregate Popularity.

A first feature (Nᵤ) for a site model corresponds to a number of times that the data-providing users have selected a particular site. This count can be constrained so that no one user is counted more than once per day. A second feature (N_{g}) corresponds to a number of times that users have issued a particular query.

Entropy.

A third feature (Entropy(Mᵤ)) represents the entropy of a site model. This feature can be approximated from the location distribution of the site model, e.g., using:

Entropy(Mᵤ)=E_{loc}[−log(P(loc|Mᵤ))]≈<−log(P(loc|Mᵤ)>.

In this expression, loc represents a location drawn from the site model Mᵤ and <f> represents an empirical mean of f drawn across many samples. A fourth feature Entropy(M_{q}) describes the entropy of a query model, and can be computed in the same manner described above.

Kullback-Leibler (KL) Divergence.

A fifth feature (KL(Mᵤ∥M_{bu})), represents the KL divergence between a particular site model (Mᵤ) and the background site model (M_{bu}). It can be expressed as follows:

$$KL ( {M}_{u} \vert \vert {M}_{bu} ) = {\int }_{loc}^{ } P ( loc \vert {M}_{u} ) log [ \frac{p ( loc \vert {M}_{u} )}{p ( loc \vert {M}_{bu} )} ] d loc .$$

The KL divergence can be computed by sampling (in the manner described above for entropy), or by using any other approximation technique. For example, the feature generation module 124 can approximate the KL divergence using any technique described in Hershey, et al., “Approximating the Kullback Leibler Divergence between Gaussian Mixture Models,” Proceedings of the IEEE International Conference on Acoustics, Speech and Signal Processing, April 2007, pp. 317-320. The appendix (Section D) sets forth a variational upper bound approximation of KL divergence described in Hershey. A sixth feature (KL (M_{q}∥M_{bq})) represents the KL divergence between a particular site model (M_{q}) and the background query model (M_{bq}), and can be computed in the same manner described above with respect to (KL(Mᵤ∥M_{bu})).

Model Width.

A seventh feature (ModelWidth(Mᵤ)) represents the mean width of a site model. This feature can be conceptualized as the broadness of appeal of an item model. The item model generation module 112 can compute this feature by sampling from the item model's distribution and computing the mean distance from the sampled mean of the distribution. In another case, the item model generation module 112 can compute this feature by determining the smallest radius within which half of the users who have selected a site are located. An eighth feature (ModelWidth(M_{q})) can be computed for the query model in the same manner.

KL Divergence between Models.

A ninth feature KL(Mᵤ∥M_{g}) represents the KL divergence between a particular site model and a particular query model. This feature can be computed in the manner described above, e.g., using sampling technique or any other approximation technique (such as a variational upper bound technique). If a site model and a query model have a similar distribution, with low KL-divergence, then it can be expected that the corresponding network-accessible site is relevant to individuals who issue this query.

Contextual Features

Assessed Location.

A tenth feature represents an assessed location of an individual, e.g., representing a longitude and latitude reading.

Probability of an Individual's Location Given a Site.

An eleventh feature (P(loc|Mᵤ)) represents the probability of an individual's location given a site model (Mᵤ). The item model generation module 112 can generate this feature by evaluating the site model at the individual's location. This feature will be high when the individual is at a location at which the site model is popular. A twelfth feature (P(loc|M_{q})) represents the probability of an individual's location, given a query model (M_{q}), and can be computed in the manner described above.

The item model generation module 112 can also generate a feature based on uncertainty associated with the assessed location of the individual, given that the individual selects a particular site. The item model generation module 112 can also generate a feature based on uncertainty associated with the assessed location of the individual, given that the individual issues a particular site. The above-described type of entropy analysis can be used to compute such features, but, here applied with respect to a particular assessed location.

Probability of a Site Given a Location.

A thirteenth feature ((P(u|loc)) represents the probability of a particular site u, given the assessed location of the individual. The item model generation module 112 can estimate this feature using Bayes rule:

$$P ( u \vert loc ) = \frac{P ( loc \vert u ) P ( u )}{P ( loc )} .$$

The term P (loc) in the denominator can be ignored because the ranking task involves ranking sites for an individual for a particular assessed location; in that case, P(loc) will be the same for all sites under consideration, and therefore does not have an effect on the ranking. The item model generation module 112 can approximate P(u) from the frequency with which the site is selected overall. Hence, the feature can be expressed as:

P(u|loc)≈NᵤP(loc|Mᵤ).

A fourteenth feature P(q|loc) represents probability of a particular query q, given the assessed location of the individual, and can be computed in the same manner described above.

Normalized Probability Features.

A fifteenth feature (P(loc|Mᵤ)ₙₒᵣₘ) represents a background-normalized counterpart to the feature (P(loc|Mᵤ)) described above, which can be computed by:

$${P ( loc \vert {M}_{u} )}_{norm} = \frac{P ( loc \vert {M}_{u} )}{P ( loc \vert {M}_{bu} ) } .$$

Without such normalization, the feature P(loc|Mᵤ) will cause bias in the computation of the above-described feature P (u|loc). Namely, the term P (loc|Mᵤ) will be large when the individual is in a high population region, and small otherwise. The feature P(loc Mᵤ)ₙₒᵣₘ provides a normalized counterpart to P(loc|Mᵤ) that can be used in computing P(u|loc) (instead of P(loc|Mᵤ)), thereby avoiding this bias.

A sixteenth feature is a variant of the P(loc|Mᵤ)ₙₒᵣₘ feature, produced by thresholding the P(loc|Mᵤ)ₙₒᵣₘ feature. That is, this feature is set to a value of 1 whenever the ratio of P(loc|Mᵤ)ₙₒᵣₘ is less than one, e.g., whenever the assessed location is less likely under the site model than under the background model. A seventeenth feature is another variant of the P(loc|Mᵤ)ₙₒᵣₘ feature, produced by renormalizing the background site model so that it sums to 1.0 over an area in which P (loc|u)>ε, for a small ε. An eighteenth feature, nineteenth feature, and twentieth feature provide counterpart query-related features to those described above for the site model.

Miscellaneous Features.

A twenty-second feature (TotalVolume) represents a percent of the site model probability mass within a particular distance d of the assessed location. A twenty-third feature (DistanceMean) represents the distance from the assessed location of the user and the mean of the site model. A twenty-fourth feature (PeakDist) represents a distance from an assessed location of the user to a nearest individual Gaussian component. A twenty-fifth feature (PeakWeight) represents the weight of the Gaussian component (associated with the PeakDist feature) in the site model. A twenty-seventh feature, twenty-eighth feature, twenty-ninth feature, and thirtieth feature provide counterpart query-related features to those described above for the site model.

To repeat, the above features are representative, not limiting or exhaustive. For example, in another implementation, the feature generation module 124 can generate another feature that represents whether or not a largest peak in a site model is located in the same city, state, country, country, etc. as the individual.

Advancing to FIG. 10, this figure shows a procedure 1000 that explains one manner of operation of the query processing system 400 of FIG. 4. In block 1002, the query processing system 400 receives a query from an end user. In block 1004, the query processing system 400 associates the query with an assessed location, which can refer either to the physical location of the user or the geographical target of the user's query, or both. In block 1006, the query processing system 400 generates a group of query-time features in response to the query, based, in part, on one or more item models. In block 1008, the query processing system 400 uses at least one ranking model, together with the query-time features generated in block 1006, to provide a list of recommended search result items. This operation can be performed in a single stage or in two (or more stages).

FIG. 11 shows a procedure 1100 that represents a dual-stage implementation of the procedure 1000 of FIG. 10, described with reference to the ranking module 502 of FIG. 5. In block 1102, the ranking module 502 receives a query from an end user. In block 1104, the ranking module 502 associates the query with an assessed location. In block 1106, the ranking module 502 generates a group of general-purpose features. In block 1108, the ranking module 502 uses a general-purpose ranking module 504 to provide a candidate list of recommended items, based on the general-purpose features computed in block 1106. In block 1110, the ranking module 502 generates a group of location-based features for the result items in the candidate list, using, in part, the item models. In block 1112, the ranking module uses a location-based ranking module 508 to re-rank the result items in the candidate list.

### C. REPRESENTATIVE COMPUTING FUNCTIONALITY

FIG. 12 sets forth illustrative computing functionality 1200 that can be used to implement any aspect of the functions described above. For example, the computing functionality 1200 can be used to implement any aspect of the training system 100 of FIG. 1, the query processing system 400 of FIG. 4, and/or the user device 402 of FIG. 4, etc. In one case, the computing functionality 1200 may correspond to any type of computing device that includes one or more processing devices. In all cases, the computing functionality 1200 represents one or more physical and tangible processing mechanisms.

The computing functionality 1200 can include volatile and non-volatile memory, such as RAM 1202 and ROM 1204, as well as one or more processing devices 1206 (e.g., one or more CPUs, and/or one or more GPUs, etc.). The computing functionality 1200 also optionally includes various media devices 1208, such as a hard disk module, an optical disk module, and so forth. The computing functionality 1200 can perform various operations identified above when the processing device(s) 1206 executes instructions that are maintained by memory (e.g., RAM 1202, ROM 1204, or elsewhere).

More generally, instructions and other information can be stored on any computer readable medium 1210, including, but not limited to, static memory storage devices, magnetic storage devices, optical storage devices, and so on. The term computer readable medium also encompasses plural storage devices. In all cases, the computer readable medium 1210 represents some form of physical and tangible entity.

The computing functionality 1200 also includes an input/output module 1212 for receiving various inputs (via input modules 1214), and for providing various outputs (via output modules). One particular output mechanism may include a presentation module 1216 and an associated graphical user interface (GUI) 1218. The computing functionality 1200 can also include one or more network interfaces 1200 for exchanging data with other devices via one or more communication conduits 1202. One or more communication buses 1224 communicatively couple the above-described components together.

The communication conduit(s) 1222 can be implemented in any manner, e.g., by a local area network, a wide area network (e.g., the Internet), etc., or any combination thereof. The communication conduit(s) 1222 can include any combination of hardwired links, wireless links, routers, gateway functionality, name servers, etc., governed by any protocol or combination of protocols.

As a closing point, the functionality described herein can employ various mechanisms to ensure the privacy of user data maintained by the functionality. For example, the functionality can allow a user to expressly opt in (and then expressly opt out of) the provisions of the functionality. The functionality can also provide suitable security mechanisms to ensure the privacy of the user data (such as data-sanitizing mechanisms, etc.).

### D. APPENDIX: VARIATIONAL UPPER BOUND APPROXIMATION OF KL DIVERGENCE

A variational approach can be used to compute an upper bound of the KL divergence between two Gaussian mixture models, as described in Hershey, et al., “Approximating the Kullback Leibler Divergence between Gaussian Mixture Models,” in Proceedings of the IEEE International Conference on Acoustics, Speech and Signal Processing, April 2007, pp. 317-320.

Consider two Gaussian components, f and g, represented by the following expressions: f=Σₐπₐfₐ and g=Σ_{b}ω_{b}g_{b}. Further consider the variational parameters φ_{b|a}≧0 and ψ_{a|b}≧0, which satisfy the constraints Σ_{b}φ_{b|a}=πₐ and Σₐψ_{a|b}=ω_{b}. The Gaussian components can be rewritten using the variational parameters as f=Σ_{ab}φ_{b|a}fₐ and g=Σ_{ab}ψ_{a|b}g_{b}.

With this notation, Jensen's inequality can be applied to provide an upper bound of the KL divergence in the following manner:

$$\begin{matrix}D ( f \vert \vert g ) = \int f log ( \frac{f}{g} ) \\ = - \int f log ( {\sum }_{ab} \frac{{ψ}_{a \vert b} {g}_{b}}{{ϕ}_{b \vert a} {f}_{a}} \frac{{ϕ}_{b \vert a} {f}_{a}}{f} ) d x \\ \leq - {\sum }_{ab} {ϕ}_{b \vert a} \int {f}_{a} log ( \frac{{ψ}_{a \vert b} {g}_{b}}{{ϕ}_{b \vert a} {f}_{a}} ) d x \\ = D ( ϕ \vert \vert ψ ) + {\sum }_{ab} {ϕ}_{b \vert a} D ( {f}_{a} \vert \vert {g}_{b} ) {=}^{def} {D}_{ϕ , ψ} D ( f \vert \vert g ) .\end{matrix}$$

The upper bound is obtained by computing the variational parameters \hat{φ} and \hat{ψ} which minimize D_{φ|ψ}(f∥g). Since the problem is convex, φ can be optimized by fixing ψ, and vice versa. Namely, the optimal value of ψ can be computed using:

$${ψ}_{a \vert b} = \frac{{ω}_{b} {ϕ}_{b \vert a}}{{\sum }_{{a}^{′}} {ϕ}_{b \vert {a}^{′}}} .$$

And the optimal value of φ can be computed using.

$${ϕ}_{b \vert a} = \frac{{π}_{a} {ψ}_{a \vert b} {e}^{- D ( {f}_{a} \vert \vert {g}_{b} )}}{{\sum }_{{b}^{′}} {ψ}_{a \vert {b}^{′}} {e}^{- D ( {f}_{a} \vert \vert {g}_{{b}^{′}} )}} .$$

The upper bound Dᵤₚₚₑᵣ(f∥g) limit is founded by successively lowering the upper bound D_{φ,ψ}(f∥g) until convergence is achieved.

In closing, the description may have described various concepts in the context of illustrative challenges or problems. This manner of explanation does not constitute an admission that others have appreciated and/or articulated the challenges or problems in the manner specified herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A training system, implemented using computing functionality, for generating item models for use in providing a personalized service, comprising:
a data collection module for providing location-tagged data, the location-tagged data identifying one or more of:
sites that have been selected by a group of data-providing users with respect to respective locations of the data-providing users; and
queries that have been issued by the group of data-providing users with respect to respective locations of the data-providing users;
a data store for storing the location-tagged data;
an item model generation module for generating a plurality of item models based on the location-tagged data, the plurality of items models including one or more of:
at least one site model that estimates a probabilistic distribution of locations for an individual, given that the individual selects a particular site; and
at least one query model that estimates a probabilistic distribution of locations for the individual, given that the individual issues a particular query; and
a data store for storing one or more of said at least one site model and said at least one query model.

2. The training system of claim 1, wherein each of said at least one site model and at least one query model comprises a Gaussian mixture model that comprises a weighted combination of Gaussian components.

3. The training system of claim 1, further comprising a feature generation module for generating a group of location-based features based on:
user online activity data that describes online activity performed by the data-providing users; and
one or more of said at least one site model and said at least one query model.

4. The training system of claim 3,
wherein the group of location-based features comprises one or more non-contextual features, selected from among:
a feature based on an aggregate popularity of a particular site;
a feature based on an aggregate popularity of a particular query;
a feature based on an entropy of said at least one site model;
a feature based on an entropy of said at least one query model;
a feature based on a divergence of said at least one site model from a background site model, the background site model describing a distribution of locations for plural selections of sites;
a feature based on a divergence of said at least one query model from a background query model, the background query model describing a distribution of locations for plural selection of queries;
a feature based on a mean width of said at least one site model;
a feature based on a mean width of said at least one query model; and
a feature based on a divergence between said at least one site model and said at least one query model,
and wherein the group of location-based features also comprises one or more contextual features, selected from among:
a feature based on an assessed location associated with the individual;
a feature based on a probability of the assessed location of the individual, given that the individual selects a particular site;
a feature based on a probability of the assessed location of the individual, given that the individual issues a particular query;
a feature based on uncertainty associated with the assessed location of the individual, given that the individual selects a particular site;
a feature based on uncertainty associated with the assessed location of the individual, given that the individual issues a particular query;
a feature based on a probability that the individual has selected a particular site, given the assessed location of the individual;
a feature based on a probability that the individual has selected a particular query, given the assessed location of the individual;
a feature based on a percent of a probability mass associated with said at least one site model that is within a particular distance of the assessed location of the individual;
a feature based on a percent of a probability mass associated with said at least one query model that is within a particular distance of the assessed location of the individual;
a feature based on a distance between the assessed location of the individual and a mean of said at least one site model;
a feature based on a distance between the assessed location of the individual and a mean of said at least one query model;
a feature based on a distance between the assessed location of the individual and a nearest mixture component of said at least one site model; and
a feature based on a distance between the assessed location of the individual and a nearest mixture component of said at least one query model.

5. The training system of claim 3, wherein the group of location-based features includes a feature based on a probability that the individual has selected a particular site or issued a particular query, given the assessed location of the individual.

6. The training system of claim 3, wherein the group of location-based features includes a feature based on a probability of the assessed location of the individual, given that the individual selects a particular site or issues a particular query.

7. The training system of claim 3, wherein the group of location-based features includes at least one of:
a feature based on a divergence of said at least one site model from a background site model, the background site model describing a distribution of locations for plural selections of sites; and
a feature based on a divergence of said at least one query model from a background query model, the background query model describing a distribution of locations for plural selection of queries.

8. The training system of claim 3, wherein the group of location-based features includes a feature based on uncertainty associated with the assessed location of the individual, given that the individual selects a particular site or issues a particular query.

9. The training system of claim 3, further comprising a ranking model generation module for generating at least one ranking model based, in part, on at least the location-based features, together with labels applied to the user online activity data.

10. The training system of claim 1, further comprising functionality for:
using said at least one query model to identify at least one of: one or more queries that are sensitive to location; and one or more queries that not sensitive to location; and
producing a dataset based on said using said at least one query model.

11. A computer readable storage medium for storing computer readable instructions, the computer readable instructions providing a query processing system when executed by one or more processing devices, the computer readable instructions comprising:
logic configured to receive a query from an end user;
logic configured to associate the query with an assessed location;
logic configured to generate a group of query-time features based, in part, on at least one item model, said at least one item model estimating a probabilistic distribution of locations for an individual, given that the individual selects a particular item; and
logic configured to use at least one ranking model, together with the query-time features, to provide at least one recommended item that is assessed as being suitable for the end user, given the assessed location that is associated with the end user.

12. The computer-readable storage medium of claim 11, wherein the query-time features include a first group of general-purpose features and a second group of location-based features, said logic configured to use said at least one ranking model comprising:
logic configured to use a general-purpose ranking model, together with the first group of general-purpose features, to generate a candidate list of one or more recommended items; and
logic configured to use a location-based ranking model, together with the second group of location-based features, to re-rank said one or more recommended items in the candidate list.

13. A method, implemented using computing functionality, for providing a personalized service, comprising:
receiving user selection data which defines selections of items by a group of data-providing users;
associating each instance of the user selection data with a metadata observation, to provide metadata-tagged data;
storing the metadata-tagged data in a data store;
generating at least one item model based on the metadata-tagged data, said at least one item model estimating a probabilistic distribution of metadata observations associated with an individual, given that the individual selects a particular item;
storing said at least one item model in a data store; and
applying said at least one item model to provide the personalized service to an end user,
said receiving, associating, storing the metadata-tagged data, generating, storing said at least one item model, and applying being performed by the computing functionality.

14. The method of claim 13, further comprising associating each instance of the metadata-tagged data with a weight that indicates a reliability of the instance of metadata-tagged data.

15. The method of claim 13, wherein:
the metadata observation that is associated with each instance of the user selection data comprises a location, and
said at least one item model estimates a probabilistic distribution of locations associated with the individual, given that the individual selects the particular item.

16. The method of claim 15, wherein:
the items selected by the group of data-providing users comprise sites, and
said at least one item model comprises a site model that estimates a probabilistic distribution of locations associated with the individual, given that the individual selects a particular site.

17. The method of claim 15, wherein:
the items selected by the group of data-providing users comprise queries, and
said at least one item model comprises a query model that estimates a probabilistic distribution of locations associated with the individual, given that the individual issues a particular query.

18. The method of claim 15, wherein said at least one item model comprises a compact model that is represented by a set of model parameters.

19. The method of claim 15, wherein said at least one item model conveys the probabilistic distribution of locations on a discrete region-by-region basis.

20. The method of claim 19, further comprising associating a level of uncertainty associated with each region.
